(19) United States
(12) Patent Application Publication
(10) Pub. No.: US 2007/0006999 A1
(43) Pub. Date: Jan. 11, 2007

(54) Fluid passageway of defrost duct for vehicles

(75) Inventor: Myeong-Kil Lee, Suwon-si (KR)

Correspondence Address: GREENBLUM & BERNSTEIN, P.L.C., 1950 ROLAND CLARKE PLACE, RESTON, VA, 20191, US

(73) Assignee: HYUNDI MOBIS CO., LTD., Seoul (KR)

(21) Appl. No.: 11/319,333

(22) Filed: Dec. 29, 2005

(30) Foreign Application Priority Data
Jul. 5, 2005 (KR) 2005-60477

(51) Int. Cl. B60H 1/00; B60S 1/54

(52) U.S. Cl. 165/203; 454/121; 454/143

(57) ABSTRACT

A fluid passageway of a defrost duct of a vehicle is constructed such that a front duct for defrosting a front glass is partitioned into a first front duct and a second front duct, and a side duct for defrosting side glasses is partitioned into a first side duct and a second side duct, so that air introduced through latticed inlet ports flows to partitioned spaces, whereby air flows to the central region and the lateral sides uniformly to achieve maximum defrosting effect.

### BACKGROUND OF THE INVENTION

1. Field of the Invention

The present invention relates to a fluid passageway of a defrost duct for vehicles, and particularly, to a fluid passage having separate right and left spaces and an air guide such that a central air flow and side air flows, which are supplied through a front duct and side ducts, respectively, are uniform, thereby improving defrosting performance.

2. Description of the Related Art

Generally, a defrost duct blows heated air to a windshield to remove frost and moisture on the windshield so that a driver can see clearly for safe driving.

The defrost duct includes an elongated discharge port formed in the upper side of an instrument panel, on which the lower end of the windshield glass is fixed in the right-to-left direction, and a duct nozzle installed in the lower side of the elongated discharge port to form a fluid passageway for guiding air supplied from a heater unit via an inlet port to the elongated discharge port.

FIG. 1 is a schematic view illustrating a conventional defrost duct, and FIG. 2 is a view illustrating a duct nozzle of the conventional defrost duct The fluid passageway of the conventional defrost duct for vehicles, as shown in FIGS. 1 and 2, includes a discharge port 8 of a defrost duct 6 elongated along the windshield glass 4 in the right-to-left direction, and a fan-shaped duct nozzle 10 installed in the lower side of the discharge port 8 of the defrost duct 6 and communicated with the discharge port 8 to distribute air blown through the defrost duct 6 to the elongated discharge port 8.

In other words, the duct nozzle 10 has an upper side extended in the right-to-left direction in comparison to the lower side such that air introduced into the lower side is guided to the elongated discharge port 8 and is jetted toward the windshield glass 4.

However, according to the fluid passageway of the conventional defrost duct of vehicles, since the discharge port has a fan-shape extended in comparison to the inlet port, when air for defrosting is introduced into the lower side and is blown toward the upper side, the flow rate at the lateral sides b of the duct nozzle 10 is lower than the flow rate at the central region of the duct nozzle 10 so that air volume discharged through the lateral sides b of the discharge port 8 of the defrost duct 6 is less than that discharged through the central region a of the discharge port 8 of the defrost duct 6.

Therefore, since air discharged through the defrost duct 6 is jetted to the central region of the windshield glass 4 at high speed, but to the lateral sides of the windshield glass 4 at low speed, there is a not-defrosted region in the lateral lower sides of the windshield glass 4.

### SUMMARY OF THE INVENTION

Therefore, the present invention has been made in view of the above and/or other problems, and it is an object of the present invention to provide a fluid passageway of a defrost duct of a vehicle for solving defrosting deterioration on a front windshield glass of a vehicle, this is caused by the air supplied to the defrost duct being concentrated to the central region thereof.

It is another object of the present invention to provide a fluid passageway of a defrost duct of a vehicle for preventing defrosting from being deteriorated due to irregular distribution of air when the defrost duct includes a front duct and side ducts to defrost a front windshield glass and side glasses.

In accordance with the present invention, the above and other aspects can be accomplished by the provision of a fluid passageway of a defrost duct of a vehicle including a front duct including a first front duct and a second front duct having spaces partitioned to discharge a defrosting air toward a windshield glass of the vehicle, a side duct installed at the side of the front duct and including a first side duct and a second side duct disposed at the right side and at the left side thereof and having spaces for discharging the defrosting air toward side glasses of the vehicle, an inlet port unit having air passageways formed in the lower sides of the side duct and the front duct to be supplied air, and partition walls for partitioning the inlet port unit such that inlet ports of the first front duct and the second front duct, and inlet ports of the first side duct and the second side duct have independent spaces, respectively.

Preferably, latticed air guides are installed in the first front duct and the second front duct along the air passageways.

The ratio of the lengths of an outer inlet port and an inner inlet port of the front duct partitioned by the air guides is 3:1.

The front duct has a cross-section gradually increased as running from an inlet port thereof to an upper discharge port

Each a single air guide is installed in the first front duct and the second front duct and extends from a lower inlet port to an upper discharge port.

The partition walls partitions inlet ports of the first front duct and the second front duct and inlet ports of the first side duct and the second side duct in the form of a lattice.

As described above, according to the present invention, air flows to the central region and the lateral sides are uniform so that maximum defrosting effect can be achieved.

### BRIEF DESCRIPTION OF THE DRAWINGS

These and/or other aspects and advantages of the present invention will become apparent and more readily appreciated from the following description of the embodiments, taken in conjunction with the accompanying drawings, in which:

FIG. 1 is a perspective view illustrating a conventional instrument panel and a conventional defrost duct installed in a vehicle;

FIG. 2 is a perspective view illustrating the conventional defrost duct of a vehicle;

FIG. 3 is a perspective view illustrating a fluid passageway of a defrost duct of a vehicle according to a preferred embodiment of the present invention;

FIG. 4 is a bottom view of the fluid passageway of the defrost duct as seen from the side “A” of FIG. 3; and

FIG. 5 is a side view of the fluid passageway of a defrost duct as seen from the side “B-B” of FIG. 3.

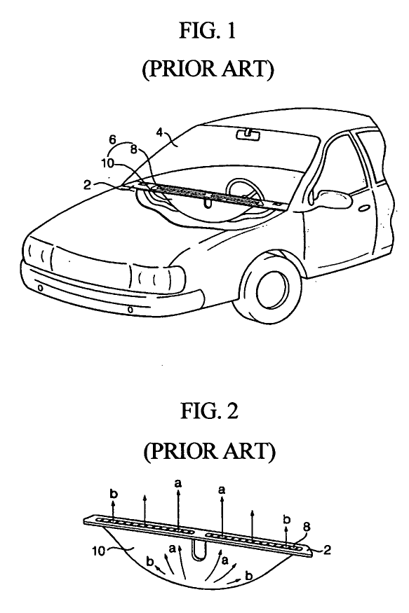

### DESCRIPTION OF THE PREFERRED EMBODIMENTS

Hereinafter, the preferred embodiments of the present invention will be described in detail with reference to the accompanying drawings.

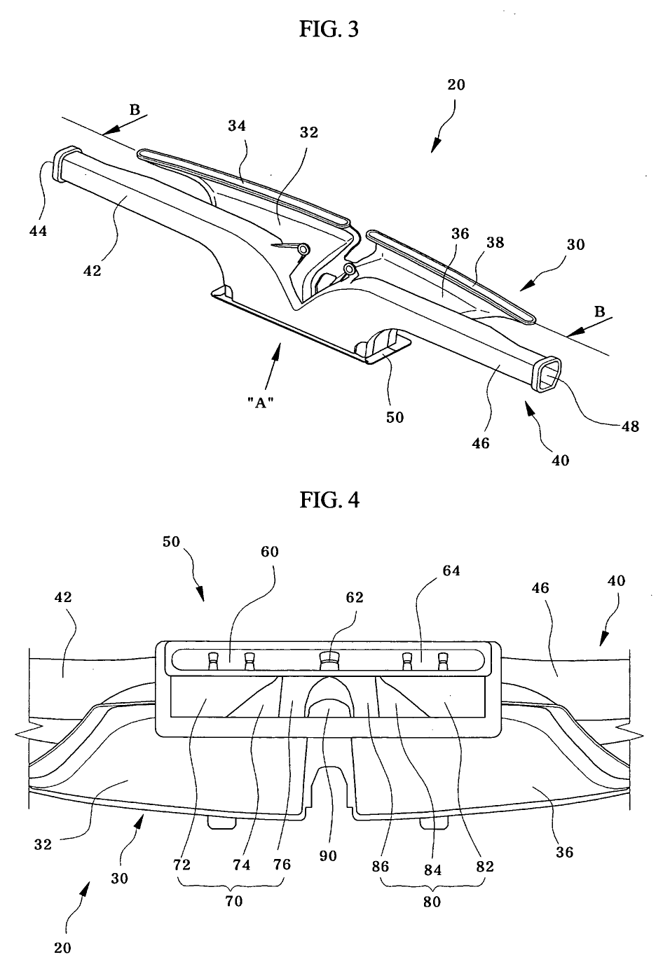

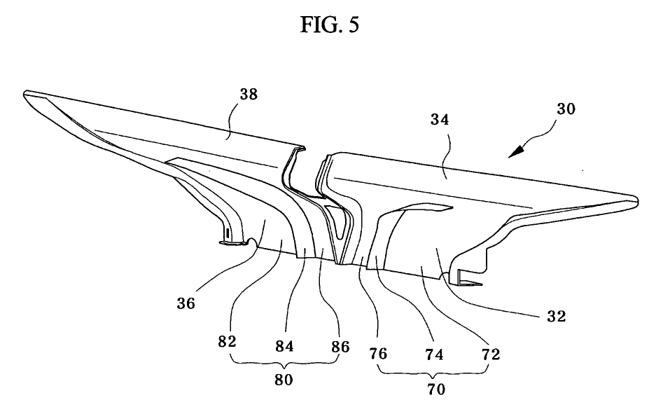

FIG. 3 is a perspective view illustrating a fluid passageway of a defrost duct of a vehicle according to a preferred embodiment of the present invention, FIG. 4 is a bottom view of the fluid passageway of the defrost duct as seen from the side “A” of FIG. 3, and FIG. 5 is a side view of the fluid passageway of a defrost duct as seen from the side “B-B” of FIG. 3.

The defrost duct 20 for blowing air to defrost a windshield glass disposed in the front side of a vehicle and side glasses disposed at the lateral sides of the vehicle, is connected to an air conditioning system of the vehicle to be supplied with air therefrom.

The defrost duct 20 includes a front duct 30 for guiding defrosting air to the windshield glass and side ducts 40 for guiding the defrosting air to the side glasses.

The front duct 30 includes a first front duct 32 and a second front duct 36, respectively having a space for discharging the defrosting air and disposed at the right and left sides thereof.

The first front duct 32 and the second front duct 36 have a front inlet port 70 and a second inlet port 80, through which air is supplied, separated from each other by a front partition wall 90 in the lower sides thereof.

Moreover, in the upper sides of the front duct 32 and the second front duct 36, a first front discharge port 34 and second front discharge port 38 are disposed to discharge the defrosting air to the windshield glass.

The front duct 30 including the fist front duct 32 and the second front duct 36 has a cross-section gradually increasing in width as it runs from the first front inlet port 70 and the second front inlet port 80 to the first front discharge port 34 and the second front discharge port 38.

At the lateral sides of the front duct 30, a side duct 40 is installed to discharge the defrosting air to the side glasses of the vehicle and includes a first side duct 42 and a second side duct 46 having partitioned spaces formed in the right and left sides thereof.

There are a first side discharge port 44 and a second discharge port 48 disposed at the lateral sides of the first side duct 42 and the second side duct 47, respectively, to discharge air, and a first side inlet port 60 and a second side inlet port 64 through which air is supplied are installed in the lower sides of the first side duct 42 and the second side duct 46 to be partitioned by a side partition wall 62.

The side inlet port 60 and the second side inlet port 64 including the first front inlet port 70 and the second front inlet port 80 constitute an inlet port unit 50 according to the preferred embodiment of the present invention, and the respective spaces are partitioned by the front partition wall 90 and the side partition wall 62.

In the preferred embodiment of the present invention, the inlet port unit 50 is formed to have lattices walls by the front partition wall 90 and the side partition wall 62 so that the inlet ports of the first front duct 32 and the second front duct 36 and the inlet port of the first side duct 42 and the second side duct 46 are partitioned such that air is distributed into the upper side, the lower side, the right side, and the left side to flow toward respective discharge ports.

Inside the first front duct 32 and the second front duct 36 which are constructed as described above, latticed air guides are installed along the air passageway.

Preferably, each one of the air guides is installed in the first front duct 32 and the second front duct 36, and extends from the first front inlet port 70 and the second front inlet port 80 at the lower side to the first front discharge port 34 and the second front discharge port 38 at the upper side.

The first front duct 32 includes a first air guide 74, the second front duct 36 includes a second air guide 84, and the lower spaces of the front ducts 32 and 36 are partitioned into a first outer inlet port 72 and a second outer inlet port 82, and a first inner inlet port 76 and a second inner inlet port 86 by the air guides 74 and 84, respectively.

In order to make the air volume supplied to the first and second outer inlet ports 72 and 82 and the first and second inner inlet ports 76 and 86 equal, the first and second air guides 74 and 84 are installed near the front partition wall 90, and preferably, the ratio of the lengths of the first and second outer inlet ports 82 and 82 and the first and second inner inlet ports 76 and 86 is 3:1 so that air is distributed uniformly.

In other words, since the traveling distance of air that has entered the first and second inner inlet ports 76 and 86 is shorter than that of air that has entered the first and second side inlet ports 60 and 64 and most of the air supplied to the inlet port unit 50 concentrates to the central region thereof, the air distribution is uniform when the first and second air guides 74 and 84, as described above, are installed near the front partition wall 90.

The first and second air guides 74 and 84, as shown in FIG. 5, have a shape gradually curved from the center to the outside as runs from the lower side to the upper side. Operation of the fluid passageway of the defrost duct of a vehicle according to the preferred embodiment of the present invention will be described.

In the air conditioning system of a vehicle, when air is supplied to the inlet port unit 50 of the defrost duct 20, the air is guided to the lateral sides by the side partition wall 62 and the front partition wall 90 respectively then enters the respective inlet ports and is discharged through the discharge ports of the respective ducts.

In detail, air entering the first side inlet port 60 flows along the first side duct 42 and is discharged through the first side discharge port 44, and air entering the second side inlet port 64 is discharged through the second discharge port 46.

Moreover, air is distributed into the first front inlet port 70 and the second front inlet port 80 by the front partition wall 90.

Air entering the first front inlet port 70 is distributed into the first outer inlet port 72 and the first inner inlet port 76 by the first air guide 74, it flows along the first front duct 32 and is discharged through the first front discharge port 34.

Meanwhile, air entering the second front inlet port 80 is distributed into the second outer inlet port 82 and the second inner inlet port 86 by the second air guide 84, it flows along the second front duct 36 and is discharged through the second front discharge port 38.

As described above, air supplied to the inlet port unit 50 of the defrost duct 20 is distributed into the respective spaces by the side partition wall 62 and the front partition wall 90 and the first and second air guides 74 and 84 so that a uniform flow rate can be provided at the central region and the lateral sides of the defrost duct 20, thereby maximizing the defrosting effect.

As described above, according to the fluid passageway of the defrost duct of a vehicle in accordance with the present invention, the inlet port unit of the defrost duct has a lattice shape to form air passageways of the side ducts and the front duct at the right side and the left side, and air is uniformly distributed into air flows in the front duct toward the central region and the lateral sides so that the defrosting deterioration can be prevented.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A fluid passageway of a defrost duct of a vehicle comprising:
a front duct including a first front duct and a second front duct having spaces partitioned to discharge a defrosting air toward a windshield glass of the vehicle;
a side duct installed at the side of the front duct and including a first side duct and a second side duct disposed at the right side and at the left side thereof and having spaces that discharge the defrosting air toward side glasses of the vehicle;
an inlet port unit having air passageways provided in the lower sides of the side duct and the front duct to supply air to the ducts; and
partition walls that partition the inlet port unit such that inlet ports of the first front duct and the second front duct, and inlet ports of the first side duct and the second side duct have independent spaces.

2. The fluid passageway of a defrost duct of a vehicle as set forth in claim 1, wherein latticed air guides are installed in the first front duct and the second front duct along the air passageways.

3. The fluid passageway of a defrost duct of a vehicle as set forth in claim 2, wherein the ratio of the lengths of an outer inlet port and an inner inlet port of the front duct partitioned by the air guides is 3:1.

4. The fluid passageway of a defrost duct of a vehicle as set forth in claim 1, wherein the front duct has a cross-section that gradually increases from an inlet port thereof to an upper discharge port.

5. The fluid passageway of a defrost duct of a vehicle as set forth in claim 1, wherein a single air guide is installed in each of the first front duct and the second front duct and extends from a lower inlet port to an upper discharge port.

6. The fluid passageway of a defrost duct of a vehicle as set forth in claim 1, wherein the partition walls partition inlet ports of the first front duct and the second front duct and inlet ports of the first side duct and the second side duct in of a lattice arrangement.

7. The fluid passageway of a defrost duct of a vehicle as set forth in claim 2, wherein a single air guide is installed in each of the first front duct and the second front duct and extends from a lower inlet port to an upper discharge port.
